(19) United States
(12) Patent Application Publication
(10) Pub. No.: US 2009/0327926 A1
(43) Pub. Date: Dec. 31, 2009

(54) METHOD AND SYSTEM FOR IMPLEMENTING SOFTWARE CUSTOMIZATION MODULE

(76) Inventors: Yi SUN, Chengdu (CN); Jianguo Liang, Chengdu (CN); Liang Zheng, Chengdu (CN); Yanzheng Sun, Chengdu (CN); Long Li, Chengdu (CN)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/489,623

(22) Filed: Jun. 23, 2009

(30) Foreign Application Priority Data
Jun. 30, 2008 (CN) 200810125274.8

(51) Int. Cl. G06F 3/00

(52) U.S. Cl. 715/762

(57) ABSTRACT

A method for implementing a software customization module is provided. The method may include receiving a function module customization request, configuring a Graphic User Interface (GUI) view and an event processing class based on the function module customization request, modifying an interface configuration file based on the function module customization request, and determining an implementation class of the event processing class based on the modified interface configuration file. A system for fulfilling software customization modules is also provided herein, wherein function modules of the system may be added or deleted without modifying the codes.

This application claims priority to Chinese Patent Application No. CN 200810125274.8, filed on Jun. 30, 2008, titled “Method and System for Implementing Software Customization Modules”, the entire contents of which are incorporated herein by reference in its entirety.

### TECHNICAL FIELD

Embodiments disclosed herein may relate to the information and computer technologies, and in particular, to a method and system for implementing software customization modules.

### BACKGROUND

With the progress of informationization, the size of storage and management software is larger and larger, and software functions are more and more diversified. Different customers have different requirements, which brings on the urgent need to flexibly add and delete function modules in the software as required by the customer.

A storage and management solution generally needs to manage storage devices according to the application requirements, with a view to fulfilling the requirement of balancing the storage of data of different importance in different application environments. Many storage and management solutions in the prior art implement the most basic integration only, and enterprises have to apply different solutions to different environments managed. However, enterprises require a uniform storage and management solution for enhancing availability, shortening the troubleshooting time and relieving the overall management load. The best return on investment to Information Technology (IT) may be realized for the user if uniform management architecture based on the industrial standard is developed in a modularized mode and open to the user application, and thus implements a harmoniously managed storage and management system.

The essence of the software plug-in technology in the prior art is to extend the software functions without modifying the program body (platform). A “platform+plug-in” software structure divides target software to be developed into two parts: one part is the main body or main framework of the program, which may be defined as a platform, and the other part is a function extension or supplementary module, which may be defined as a plug-in.

I. A “platform+plug-in” structure may be divided into two parts:

1. Basic functions of the platform: The basic functions of the platform should be a core and foundation of the software system. Such basic functions may be available to the user or plug-in. In this way, the basic functions of the platform may be further divided into two parts:

(1) Kernel function: The kernel function of the platform is an important function of the whole software. A majority of the functions of the software are undertaken by the kernel function.

(2) Plug-in processing functions: The plug-in processing functions of the platform include registration, management and invocation of plug-ins, and implementation of the functions of the extended interfaces of the platform.

2. Extended plug-in functions: The functions of the plug-in are an extension and supplement to the platform functions.

II. The “platform+plug-in” software structure requires definition of two standard interfaces:

1. Extended interface of the platform: implements unidirectional communication from the plug-in to the platform. Through the extended interface of the platform, the plug-in can access various resources and data of the main framework, including various system handles, internal data of a program, and memory allocation.

2. Plug-in interface for the plug-in: A plug-in interface implements unidirectional communication from the platform to the plug-in. Through a plug-in interface, the platform invokes the functions of the plug-in, and reads the plug-in processing data.

Currently, plug-ins include small function extensions. Most functions of the software are undertaken by the kernel function. Therefore, if the requirements have changed substantially, the kernel codes must be modified, and it is not practicable to add or delete function modules of a platform flexibly. For the software based on a “platform+plug-in” structure, all plug-ins are managed by the plug-in processing function of the platform uniformly, including registration, management and invocation of plug-ins, and implementation of the functions of the extended interface of the platform, which leads to excessive overhead of the system.

The software integration in the prior art uses simple software structures. Too many restrictions are imposed on adding or deleting modules of a software product in the prior art. Such addition or deletion generally requires modification of the platform codes, and leads to incompatibility with the old versions.

### SUMMARY

Embodiments disclosed herein may provide a method and system for customizing function modules, and adding or deleting function modules of a software system without modifying codes.

A method for customizing function modules, is provided, which includes: receiving a function module customization request, configuring a Graphic User Interface (GUI) view and an event processing class based on the function module customization request, modifying an interface configuration file based on the function module customization request, and determining an implementation class of the event processing class based on the modified interface configuration file.

A system for implementing a software customization module is also provided. The system includes a receiving unit, adapted to receive a function module customization request; a first configuring unit, adapted to configure a Graphic User Interface (GUI) view and event processing class based on the function module customization request, and modify an interface configuration file based on the function module customization request; a second configuring unit, adapted to determine an implementation class of the event processing class based on the modified interface configuration file.

In some embodiments of the present disclosure, the system configures a Graphic User Interface (GUI) view and event processing class based on the function module customization request, and determines an implementation class of the event processing class based on the modified interface configuration file which is modified based on the function module customization request, thus being able to add or delete function modules of the software system without modifying codes.

### BRIEF DESCRIPTION OF THE DRAWINGS

The accompanying drawings, which are incorporated in and constitute a part of this specification, illustrate some embodiments and together with the description, serve to explain the principles of the embodiments disclosed herein.

FIG. 1 is a class diagram of a software GUI subsystem according to some embodiments.

FIG. 2 is a main page loading flowchart of a GUI subsystem according to some embodiments.

FIG. 3 is a sequence diagram of processing a click event according to some embodiments.

FIG. 4 is a class diagram of a software function subsystem according to some embodiments.

FIG. 5 is a flowchart of a method for implementing a software customization module according to some embodiments.

FIG. 6 shows a system for implementing a software customization module according to some embodiments.

### DETAILED DESCRIPTION

Reference will now be made in detail to embodiments disclosed in the accompanying drawings. Wherever possible, the same reference number will be used through the drawings to refer to the same or like parts. Evidently, the embodiments described below are for the exemplary purpose only.

Generally, a software system includes two parts: a graphical user interface (GUI) part and a function part. The customization of function modules in accordance with some embodiments relates to two subsystems: GUI subsystem, and function subsystem. The GUI subsystem is adapted to display GUIs, and the function subsystem is adapted to store data and implement the logic processing part of each service function module.

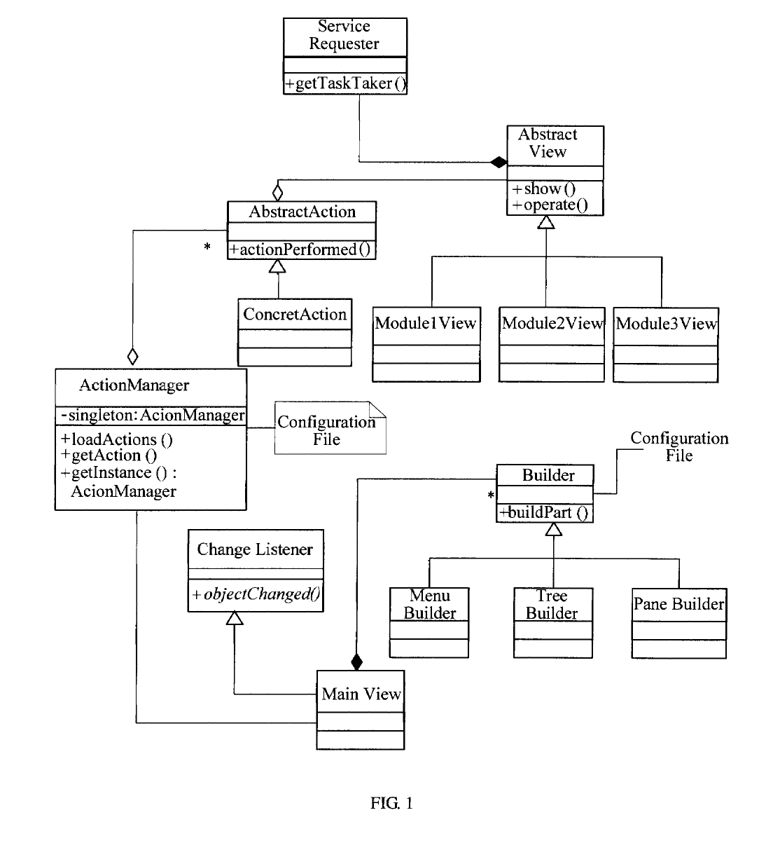

FIG. 1 is a class diagram of the GUI subsystem. As shown in FIG. 1, the builder module builds the menus, trees and panes required by various GUIs in the MainView according to the configuration file provided by the user. The ChangeListener interface is adapted to monitor various changes of the function module, and provide the changes for the MainView to change the display information on the GUI. The ActionManager is responsible for loading all actions and storing the actions, namely, event processing class ConcreteAction, and the AbstractView is a parent class of all views (such as Module1View). FIG. 1 shows a static structure of a GUI subsystem of a module, especially shows the classes and interfaces existent in the GUI subsystem, and the static structures and relations between them. The GUI subsystem is adapted to implement the display function of the interface.

Abstract class (Action): a base class of the event processing class of all menus, toolbar menus, and shortcut menus. The abstract class is an inheritance from the Abstract Action in the swing (action in the swing package). Swing is a GUI toolkit in Java.

Event processing class (ConcreteAction): a subclass of Action, and event processing class of a specific menu. For example, as regards a “save” menu, the function of saving may be available in the menu, toolbar, and shortcut menu. Therefore, a specific action such as ConcreteAction needs to be built to implement the function of saving.

Base class manager (ActionManager): provides loading and management for all actions. All actions are managed in a configuration file. The operations of adding and deleting an action are performed in the configuration file. The functions provided by the ActionManager include: loading all actions from a configuration file, and saving them. When a menu item needs to use an action, the action is obtained from the ActionManager. The ActionManager is implemented through a singleton model.

Service requester (ServiceRequester): through the ServiceRequester class, a portal to the function subsystem is obtained. If the GUI needs to use a function, the operation object (for example, a specific task: TaskTaker object) of the function is obtained through the ServiceRequester. For example, for the module which processes an alarm, if the alarm GUI needs to use the alarm query function of the alarm task module (AlarmTaskTaker), it is necessary to obtain the AlarmTaskTaker through the ServiceRequester.

Information change listener (ChangeListener): Because the implementation is divided into a function subsystem and GUI subsystem, the data change of the function subsystem needs to be notified to the GUI subsystem instantly, and the GUI subsystem needs to monitor the change of the function subsystem. The ChangeListener is an interface for monitoring the function subsystem.

AbstractView: The views (primarily pop-up windows) of every specific module needed to implement the AbstractView class.

Operation function views of specific modules: Module1View, Module2View, and Module3View, adapted to inherit the AbstractView. For example, the page for creating and querying RaidGroup is a view of the RaidGroup module; the page for querying and deleting alarms is a view of the alarm module.

Builder: a base class of the builder mode.

TreeBuilder, MenuBuilder, and PaneBuilder: These three builders are inheritances from Builder, and enable creation of trees, menus and panes. A GUI include 5 parts: menus, toolbar, left tree, right pane, and status bar. TreeBuilder is adapted to build a left tree, MenuBuilder is adapted to build a menu, and PaneBuilder is adapted to build a right pane. The configurations of trees, menus and panes are placed in the configuration file. Such builders build objects according to the configuration files.

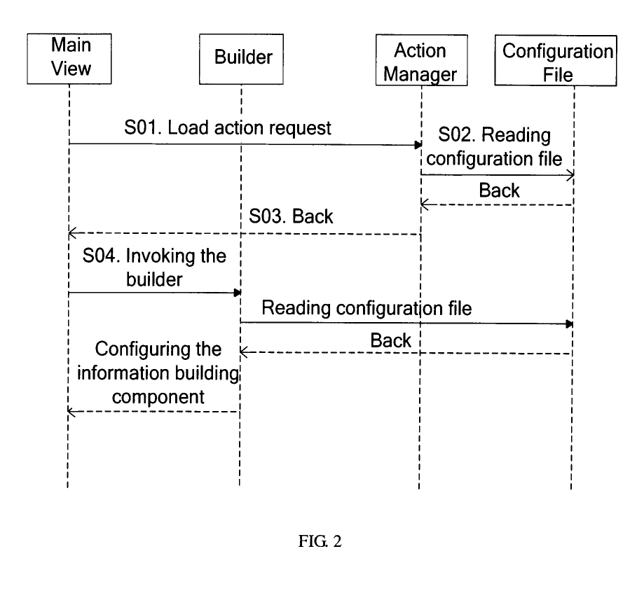

FIG. 2 illustrates the loading process of the MainView.

MainView is a main page of the GUI subsystem. It is responsible for directing the builder mode (invoking the builder role to build a specific object), and is adapted to build menus, trees and pane pages. The loading process of the MainView includes the following steps:

S01: The MainView sends a LoadAction request to the ActionManager.

S02: The ActionManager reads the configuration file of the existing load action according to the LoadAction request.

S03: The read configuration file is returned to the MainView.

S04: The MainView invokes the Builder, including MenuBuilder, TreeBuilder and PaneBuilder.

A specific builder builds a component according to the configuration information in the configuration file, and returns the built component to the MainView.

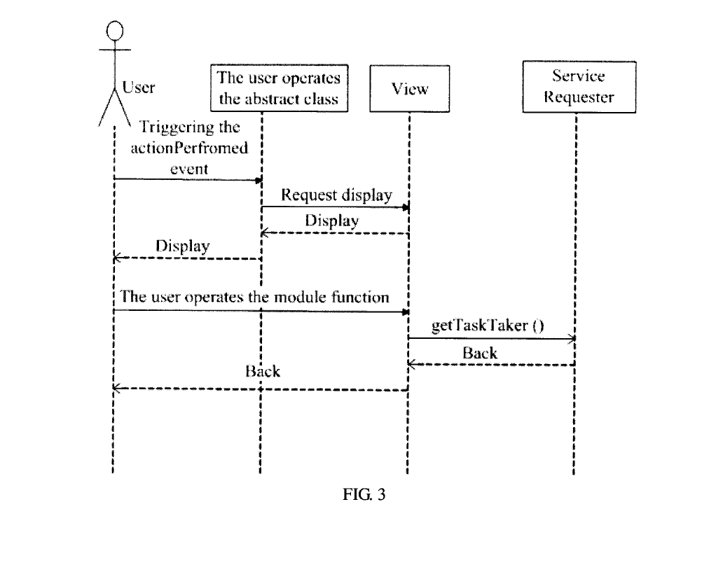

FIG. 3 shows a process of interaction between the module of the GUI subsystem and the function subsystem, taking the processing of the mouse clicking the operation event as an example. The process includes the following steps:

S201. The user clicks a menu (or clicks a button in the toolbar, or right clicks) to trigger an action.

S202. The action displays an operation GUI (ModuleView).

S203. The user operates the GUI.

S204. The GUI subsystem obtains the TaskTakerInterface required by the user through a ServiceRequester.

S205. The ModuleView invokes the TaskTakerInterface to enter the function subsystem.

S206. The function subsystem returns the execution result to the ModuleView, and displays the operation result.

The foregoing description reveals that the solution in this embodiment involves three parts (ActionManager, MainView, and Builder), the specific modules (ModuleView, and Action) and additionally, the menus, toolbar, right key, and pane. A process of adding a module includes the following steps:

A. The menu item to be added is determined according to the function customized by the user. Each menu item implements a specific event process class (ConcreteAction). Configurations are added in the configuration file of the Action. The configuration file of the Action is an Action class adapted to configure the click of all shortcut menus or pull-down menus.

B. The menu and toolbar file are configured. This file is available for loading when the MenuBuilder generates a menu, and the menu is generated according to the configuration in the file.

C. The function view (namely, ModuleView) of the added module is determined. Such ModuleViews primarily refer to the pop-up windows to be displayed during the action.

D. The left tree is determined. At the time of adding a module, some new tree nodes may need to be added, which requires reconfiguration of the configuration file of the tree. The configuration file of the tree is loaded when the TreeBuilder generates the tree.

E. A pane is determined. If a node is added for the left tree, the node needs to be added for the right pane accordingly. After a pane is added, the pane file needs to be configured. The configuration file is loaded when the PaneBuilder generates the corresponding pane.

A process of deleting a module includes the following steps:

A1. According to the customization of the user, the configuration file is modified when the specified function is deleted. The Action class of the split mirroring is removed from the Action.xml file, and the corresponding nodes and subnodes are deleted from the Tree.xml file.

B1. The interface configuration file is modified: The “HypperCloneWorkTakerInterface=Interface.HypperCloneWorkTakerImpl” statement is removed from the ViewFunctionInterface.properties.

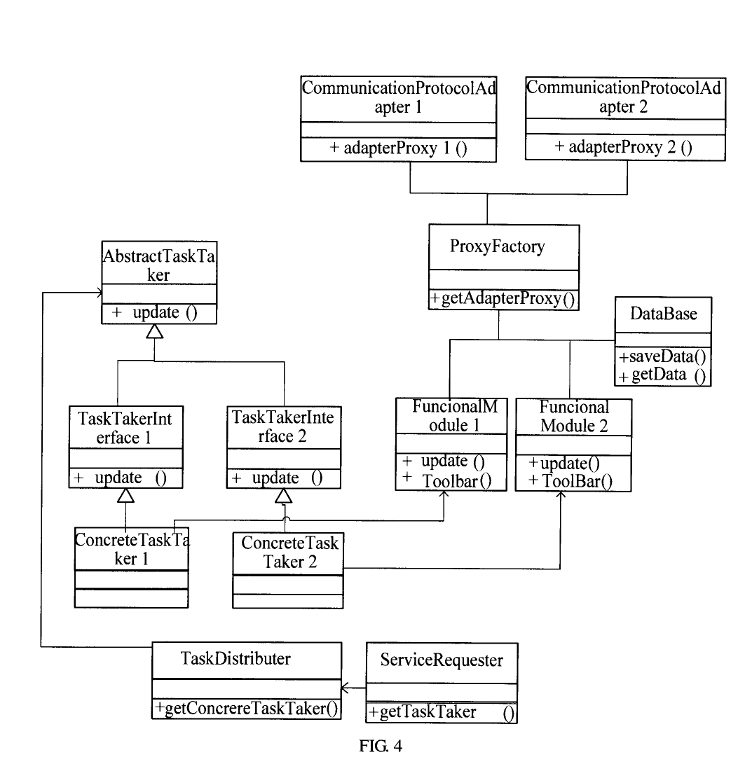

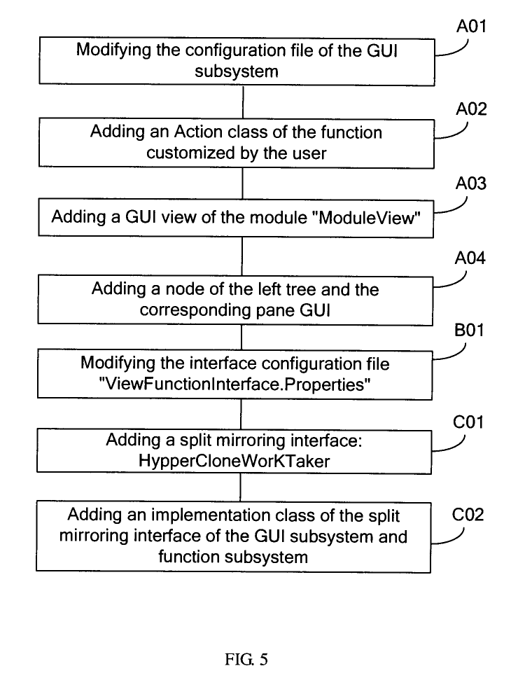

FIG. 4 is a class diagram of the function subsystem. After receiving a task of the GUI subsystem, the ServiceRequester invokes the TaskDistributer, and searches for the AbstractTaskTaker that needs to be invoked, namely, finds the TaskTakerInterface1 in that way, and finally finds the specific implementation class of the task (namely, ConcreteTaskTaker). Meanwhile, the implementation class invokes the relevant function processing module (namely, FunctionalModule1) to perform relevant operations such as update. At the same time, the function processing module invokes the database to save the data, and so on. The protocol processing class obtains the specific communication protocol adapter (namely, CommunicationProtocolAdapter1) according to the function task processing module. FIG. 5 shows a static structure of the function subsystem, especially shows the classes and interfaces existent in the function subsystem, and the static structure and relations between them. The function subsystem is adapted to generate instances of specific tasks, convert the specific adaptation object, and save the objects into the database.

As shown in FIG. 4, the function subsystem includes the following modules:

ServiceRequester: adapted to interact between the GUI subsystem and the function subsystem, receive the service request from the GUI subsystem, and request the function subsystem for the service to be operated.

TaskDistributor: available for being invoked by the ServiceRequester, and adapted to obtain the specific task (taskTaker) such as ConcreteTaskTaker1.

AbstractTaskTaker: a parent class of all task interfaces, responsible for the functions similar to the functions of a SERIALIZABLE class in the JIAVAR JDK.

TaskTakerInterface: an inheritance from AbstractTaskTaker.

ConcreteTaskTaker: inheriting the TaskTakerInterface to implement the functions of the function module in the TaskTakerInterface.

FunctionModule: a function module processing class, which is available for being invoked by the ConcrereTaskTaker and provides the functions such as logic processing of each task.

Database: adapted to store the data used by the function module, including the data delivered by the ConcreteTaskTaker through the FunctionalModule to the CommunicationProtocolAdapter and the data reported from the CommunicationProtocolAdapter.

ProxyFactory: obtaining the specific protocol adapter.

The CommunicationProtocolAdapter receives the invocation of the ConcreteTaskTaker, converts the processing object in it to a universal object identifiable to the managed device, and converts the object obtained from the device side to the universal object identifiable to the specific TaskTaker.

As shown in FIG. 4, the correlated code part needs to be added at the time of adding a new module, and the TaskDistributor generates an instance of the ConcreteTaskTaker automatically.

For example, in the process of adding a module in the GUI subsystem, the function subsystem needs to add an interface (TaskTakerInterface2) of this module, implement this interface (namely, adding SererModule2), add the logic processing part of the task (namely, add SererModule2) according to the actual conditions, and add a protocol adaptation object (CommunicationProtocolAdapter2) after conversion of the task.

Each module of the GUI subsystem corresponds to a ConcreteTaskTaker of the function subsystem. In this way, the interface of one module does not interfere with the interface of another module, and the GUI subsystem obtains the corresponding interface through only one step. Moreover, in the case of extending with new module, the new interface module may be generated automatically without modifying the existing program.

When a module needs to be added into the software system/platform, the newly added function interface can be processed without the need of modifying the interface processing mechanism between subsystems.

As described above, an interface and its implementation class are configured at the function subsystem so that the function modules of the software system may be added or deleted without modifying the codes. In this way, the GUI modules required by the user are generated through the configuration file, the user customizes the software functions, the extensibility of the software functions is enhanced greatly, and the development cycle is shortened substantially.

The embodiments discussed above are elaborated below, taking the split mirroring function as an example.

As shown in FIG. 5, according to the user request of customizing the split mirroring function, a new function is added at a node (Logical Unit Number (LUN)) in the left tree, and a new function is added in its shortcut menu to customize the specific GUI subsystem part (creating a split mirroring). The method for customizing a software module in some embodiments include:

A. The GUI subsystem is configured.

A01. The configuration file is modified.

(a1) Action.xml (a configuration file read by the ActionManager) is configured: Supposing that the action of the pop-up window of the function is HyperCloneAction, the parameters are defined and configured consecutively in the Action.xml configuration file in the following structure mode: actionID, which is adapted to uniquely identify the class action, className (mandatory), mnemonic acceleration key, and shortcut key (optional).

```
<action>
    <actionID>hyperClone</actionID>
    <className>HyperCloneAction</className>
    <mnemonic>o</mnemonic>
    <accelerator></accelerator>
      </action>
```

(a2) The menu.xml file is modified for the purpose of adding an action operable by a specified user (such as administrator and ordinary user) and correlating the action with the actionID in Action.xml. The menus may be defined into level-1 menus and level-2 menus. The structure is as follows:

```
<menu name=“System”>
        <mnemonic>s</mnemonic>
        <items>
          <item>
            <type>menuItem</type>
            <actionID>hyperClone</actionID>
            <users>
              <user>common</user>
<user>admin</user>
            </users>
    </item>
    </items>
</menu>
```

A02. An Action class of the function is added.

Here an Action class for implementing the split mirroring function, namely, HyperCloneAction, needs to be added, with a view to implementing the function of creating a split mirroring. As shown in FIG. 1, the Action inherits the AbstractAction, and its details are not described here any further.

A03. A GUI view of the module (namely, ModuleView) is added.

Such a ModuleView primarily refers to the GUI that needs to be displayed in the Action processing. Supposing that the pop-up GUI of the split mirroring is HyperCloneView, the user needs to process the split mirroring GUI and its logic functions in this class.

A04. The nodes of the left tree and the corresponding pane GUI (LunPropertyPane: This GUI includes the information about the corresponding Lun node, for example, split mirroring information) are added.

Specifically, the corresponding subnode is configured according to the node hierarchy of the left tree.

Supposing that the node hierarchy of the left tree is:

```
level-1 node: Root node
subnode of Root node: Raid node
subnode of Raid node: Lun
then the structure of the configuration file is as follows:
<tree name=“Root”> //alias of the tree node
    <treeNode name=“RAID”> //treeNode name
        <class> //TreeNode corresponding to the tree node
          RaidTreeNode
        </class>
        <propertyPane> //configure the class of the right pane
            RaidPropertyPane
          </propertyPane>
    <children>
        //lower-level subnode
      <treeNode name=“Lun”>
      <class> //TreeNode corresponding to the tree node
          LunTreeNode
        </class>
      <propertyPane> //configure the class of the right pane
        LunPropertyPane-------here it is a newly added pane GUI
        </propertyPane>
      </treeNode>
      </children>
      </treeNode>
      </tree>
```

B. An interface between the GUI subsystem and function subsystem is added.

For example, as shown in FIG. 4, it is necessary to add a HypperCloneWorkTaker in the ServiceRequester module of the function subsystem to ensure that the GUI subsystem can obtain the specific workTaker and the implementation interface correctly at the time of invocation.

B01. The interface configuration file is modified.

The interface between the GUI subsystem and function subsystem is resolved and obtained through the configuration file (ViewFunctionInterface.properties), thus enabling the user to add and delete interfaces conveniently at the user's discretion. That is, it is only necessary to add the following line of information in the ViewFunctionInterface.properties:

HypperCloneWorkTakerInterface=Interface.HypperCloneWorkTakerImpl, where the left side is an interface that needs to be implemented and the right side is a path of the implementation class of the specific interface.

C. A function subsystem is configured.

C01. A split mirroring interface “HypperCloneWorKTaker” is added.

C02. An implementation class “HypperCloneWorKTakerImpl” of the split mirroring interface of the GUI subsystem and function subsystem is added.

The interface required for split mirroring is invoked. This operation is handled by the implementation class “HypperCloneWorKTakerImpl” in the function subsystem, and the detailed function is not described any further.

The foregoing user customization module is deleted from the GUI subsystem and function subsystem. The detailed process is as follows:

In the GUI subsystem, the configuration file is modified: The Action class of the split mirroring is removed from the Action.xml file, and the corresponding nodes and subnodes are deleted from the Tree.xml file. In this way, the functions of a module can be deleted conveniently.

In the function subsystem, the statement “HypperCloneWorkTakerInterface=Interface.HypperCloneWorkTakerImpl” is deleted from the ViewFunctionInterface.properties.

In the detailed process of implementing the configured split mirroring function module, the GUI subsystem interacts with the function subsystem, including the following steps:

S31. The GUI subsystem displays the GUI of split mirroring.

The GUI subsystem displays the relevant contents of the split mirroring.

S32. The relevant parameters are configured on the GUI.

In order to create a split mirroring, the required parameter information is: name of the split mirroring to be created, buffer time, and specific LUN selected.

S33. The GUI subsystem invokes the function subsystem to process the task object “HypperCloneWorKTaker” of the split mirroring.

S34. After obtaining the task object, the GUI subsystem invokes the specific interface of the task object again.

S35. After completion of the specific interface of the task, the GUI subsystem displays the relevant prompt information to the user.

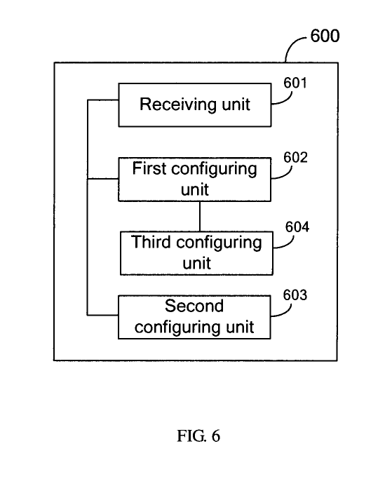

A system for implementing a software customization module is also provided in an embodiment of the present invention. As shown in FIG. 6, the system 600 includes a receiving unit 601, a first configuring unit 602, and a second configuring unit 603.

The receiving unit 601 is adapted to receive a function module customization request of the user.

The first configuring unit 602 is adapted to configure an event processing class file and parameters of a function customized by the user in a GUI subsystem according to a function module customization request received by the receiving unit, add an event processing class of the function customized by the user, determine the GUI view of the added function module, and modify the interface configuration file of the GUI subsystem and function subsystem according to the function module.

The configured parameters include actionID and className.

The second configuring unit 603 is adapted to configure an interface and configure an implementation class under the event processing class of the customized function in the GUI subsystem or function subsystem according to the modified interface configuration file.

The first configuring unit 601 is further adapted to modify the configuration file of the GUI subsystem according to the function module customization request of the user, where the modification of the configuration file of the GUI subsystem includes:

configuring an ID which uniquely identifies the class, a class name, and parameters.

The system further includes:

a third configuring unit 604, adapted to add an Action operable by a specified user, and correlate with the event processing class file through the parameter “actionID”.

The system further includes:

a database configuration unit, adapted to configure a database for storing the data used by the function module.

The system further includes:

a communication protocol configuration unit, adapted to configure a CommunicationProtocolAdapter.

In summary, in the technical solution provided in an embodiment of the present invention, the system configures an event processing class file and parameters of the function customized by the user in the GUI subsystem according to the function module customization request of the user; adds left tree nodes, adds the event processing class of the function customized by the user, and adds the interface configuration file of the GUI subsystem and function subsystem; and configures an interface and its implementation class in the function subsystem, thus being able to add or delete function modules of the software system without modifying codes. In this way, the GUI modules required by the user are generated through the configuration file, the user can customize the software functions, and the customer requirements are more satisfied. Because the modules are independent of each other, addition of a new function needs no modification of the existing function codes, thus shortening the development cycle of adding a new function. The flexible combination of function modules reduces coupling between modules, and makes the software system more maintainable and adaptable to a wider management scope. The adaptive addition and removal of function modules can implement management on diversified devices to meet the requirements of different users in different environments.

It is understandable to those skilled in the art that all or part of the preceding embodiments can be implemented by hardware instructed by a program. The program may be stored in a computer-readable storage medium, and be executed by a processor. When being executed, the program may include the processes of all the foregoing method embodiments. The storage medium may be a magnetic disk, compact disk, Read-Only Memory (ROM), Random Access Memory (RAM), and so on.

Although the invention has been described through several preferred embodiments, the invention is not limited to such embodiments. It is apparent that those skilled in the art can make various modifications and variations to the disclosed embodiments without departing from the spirit and scope of the embodiments disclosed herein. The true scope and spirit of the disclosed embodiments are intended to cover the modifications and variations provided that they fall in the scope of protection defined by the claims or their equivalents.

What is claimed is:

1. A method for customizing function modules, comprising:
receiving a function module customization request;
configuring a Graphic User Interface (GUI) view and an event processing class based on the function module customization request;
modifying an interface configuration file based on the function module customization request; and
determining an implementation class of the event processing class based on the modified interface configuration file.

2. The method for customizing function modules according to claim 1, further comprising:
sending, by a MainView of the GUI view, a LoadAction request to an ActionManager;
reading, by the ActionManager, existing load configuration files and sending the files to the Main View; and
invoking, by the MainView, a Builder and building a component according to the existing load configuration files.

3. The method for customizing function modules according to claim 2, wherein configuring the GUI view based on the function module customization request comprises:
determining menu items that need to be added based on the function module customization request;
modifying a plurality of configuration files corresponding to the menu items; and
determining a GUI view based on the modified configuration files.

4. The method for customizing function modules according to claim 3, further comprising:
determining a left tree and modifying a plurality of configuration files corresponding to the left tree; and
determining a pane and modifying a configuration file corresponding to the pane.

5. The method for customizing function modules according to claim 2, wherein configuring the GUI view comprises:
deleting a specified function configuration file based on the function module customization request; and
modifying the interface configuration file corresponding to the function module.

6. The method for customizing function modules according to claim 2, further comprising:
configuring a database for storing the data used by the function module.

7. The method for customizing function modules according to claim 2, further comprising:
configuring a Communication Protocol Adapter.

8. A system for customizing function modules, comprising:
a receiving unit, adapted to receive a function module customization request;
a first configuring unit, adapted to configure a Graphic User Interface (GUI) view and an event processing class based on the function module customization request, and modify an interface configuration file based on the function module customization request; and
a second configuring unit, adapted to determine an implementation class of the event processing class based on the modified interface configuration file.

9. The system for customizing function modules according to claim 8, further comprising:
a database configuration unit, adapted to configure a database for storing the data used by the function module.

10. The system for customizing function modules according to claim 9, further comprising: a communication protocol configuration unit, adapted to configure a Communication Protocol Adapter.
